(19) United States
(12) Patent Application Publication
(10) Pub. No.: US 2006/0089426 A1
(43) Pub. Date: Apr. 27, 2006

(54) Alkoxylated epoxide-amine adducts and their use

(76) Inventors: Karlheinz Haubennestel, Wesel (DE); Udo Krappe, Emmerich (DE); Joerg Boemer, Wesel (DE)

Correspondence Address: Schwegman, Lundberg, Woessner & Kluth, P.A., P.O. Box 2938, Minneapolis, MN, 55402, US

(21) Appl. No.: 11/255,093

(22) Filed: Oct. 20, 2005

(30) Foreign Application Priority Data
Oct. 20, 2004 (DE) DE 10 2004 050 95

(51) Int. Cl. C08K 3/20

(52) U.S. Cl. 523/404

(57) ABSTRACT

The invention relates to alkoxylated epoxide-amine adducts having a number-average molecular weight of more than 500 g/mol, which are preparable by reacting A) mono- and/or polyepoxides having at least 8 carbon atoms with B) primary and/or secondary amines and/or primary and/or secondary alkanolamines and/or secondary alkylalkanolamines, to form an adduct having one or more secondary OH groups, and subsequently alkoxylating the adduct with C) alkylene oxides. The invention also relates to a process for preparing the alkoxylated epoxide-amine adducts and to their use as wetting agents and dispersants for organic and inorganic pigments and fillers. The invention relates further to powderous or fibrous solids coated with the alkoxylated epoxide-amine adducts.

### RELATED APPLICATION

This application claims priority under 35 U.S.C. 119 to German Application No. 10 2004 050 955.7, filed Oct. 20, 2004, which application is incorporated herein by reference and made a part hereof.

The present invention relates to innovative aminic polyalkylene oxides based on epoxy-amine adducts and also to the reaction products of these aminic poly-alkylene oxides. This invention further relates to the use of the aminic polyalkylene oxides as wetting agents and dispersants for organic and inorganic pigments and fillers in organic and aqueous systems, and to powderous or fibrous solids intended for incorporation into liquid systems and coated with such dispersants.

The aforementioned aminic polyalkylene oxides are particularly suitable for producing aqueous or solvent-based pigment concentrates (pigment pastes) and also for stabilizing particulate solids in binders, coating materials, plastics and mixtures of plastics. These products reduce the viscosity of such systems, improve flow properties and storage stabilities, and increase the colour strength.

The ability to introduce solids into liquid media presupposes high mechanical forces. It is usual to use dispersants in order to lessen these dispersing forces and in order to minimize the total energy input into the system, as needed to deflocculate the particulate solids, and hence also to minimize the dispersing time. These dispersants are generally surface-active substances, of anionic, cationic or neutral structure. They are employed in smaller amounts and either applied directly to the solid or added to the dispersing medium. It is also known that, following complete deflocculating of the agglomerated solids into primary particles, instances of reagglomeration occur after the dispersing operation, thereby bringing some or all of the dispersing effort to naught. A consequence of the inadequate dispersion, or a result of reagglomeration, are unwanted effects such as viscosity increase in liquid systems, shade drift and loss of gloss in paints and coatings, and a reduction in mechanical strength in plastics.

A multiplicity of different substances are presently used as dispersants for pigments and fillers. A review of existing patent literature is found in EP 0 318 999 A2 (page 2, lines 24-26). Besides very simple compounds of low molecular mass, such as lecithin, fatty acids and their salts, and alkylphenol ethoxylates, for example, complex structures, too, are used as dispersants.

Among those compounds used as wetting agents and dispersants are also reaction products of epoxides with amine-containing compounds. Thus U.S. Pat. No. 5,128,393 and U.S. Pat. No. 4,710,561 describe reaction products of monoepoxides with aminoimidazolines. DE 690 02 806 T2 (U.S. Pat. No. 5,128,393 A) describes the use of reaction products of monoepoxides or polyepoxides with amines which maintain an imidazoline moiety as dispersants.

(Poly)epoxides have been known for a long while as constituents of binders. Such systems are often contacted with amines as hardener components, and cured. In recent publications on this and related topics, specific amines or amine-epoxide adducts are described as hardeners for epoxy resins.

For instance, self-dispersible curable epoxy resins, as a result of reactions of aromatic polyepoxides with polyoxyalkylenamines in an equivalent ratio (epoxy equivalent:amine equivalent) of between 1:0.1 and 1:0.28, are found in DE 198 58 920 A1 (U.S. Pat. No. 6,506,821 B1). Since the epoxide group content of such compounds is considerable they are unsuitable for use as wetting agents and dispersants, since on the one hand the pigment concentrates produced lack adequate storage stability and on the other hand there is no broad compatibility with different binders. Similar products are also described in U.S. Pat. No. 3,945,964 and U.S. Pat. No. 4,485,229 as aqueous emulsifiers. Furthermore, U.S. Pat. No. 4,051,195 and EP-A-0 245 559 describe crosslinkers based on epoxides with polyoxyalkylenamines, which in addition have been reacted with acrylic esters in a Michael reaction. Since these products as well are intended to function as a crosslinker component, in those examples as well the density of crosslinkable groups is high, so rendering the products unusable as dispersants. This restriction also applies to products of WO 96/20971, which describes reaction products of epoxy resins with amine-epoxide adducts as self-emulsifying curable epoxy resins. The aforementioned amine-epoxide adducts are reaction products of polyepoxides with a substoichiometric amount of polyoxyalkylenediamines.

EP 747 413 A2 describes, as emulsifiers, reaction products of aliphatic polyols with epoxides having at least two epoxide groups per ring. These compounds, therefore, do not carry any nitrogen atoms from which salts can be formed, and hence show little affinity for pigments and fillers.

Common to all of the aforementioned dispersants is that they have each been developed only for a narrowly defined field of use and therefore are of only limited usefulness especially in relation to a common use in systems varying sharply in polarity.

In pastes known as universal tinting pastes, by which are meant pigment pastes used principally in the architectural paint industry for tinting (colouring) aqueous, cosolvent-containing or solvent-containing coating systems, alkylphenol ethoxylates and/or their phosphoric esters have long been used as wetting agents and dispersants. In contrast to the epoxide adducts used above as dispersants, these substances are notable for broad compatibility in the binders used. For toxicological reasons, however, these substances have come under criticism, and in certain countries are already subject to strong restrictions governing their use.

Alternatively to the alkylphenol ethoxylates, fatty alcohol ethoxylates and/or their phosphoric esters are used for preparing tinting pastes. The positive properties of the alkylphenol ethoxylates in respect of the pigment stabilization are not achieved in the majority of cases by the fatty alcohol ethoxylates. Moreover, the propensity for stabilizing foam is an adverse side-effect of many fatty alcohol ethoxylates.

Besides the said fatty alcohol ethoxylates and their derivatives, use is also made of block-copolymeric phosphoric esters and their salts (DE-A-100 29 648/US 2002011183 A1) and also styrene oxide-containing polyalkylene oxides (DE-A-199 40 797/EP 0001078946 A1) as dispersants.

Compounds based on alkoxylated ethylenediamine can be regarded as prior art in the field of basic polyalkylene oxides. Substances of that kind are available commercially under the brand name Tetronic or Quadrol from BASF AG (e.g. Tetronic RED 9040) and also under the brand name Genapol (e.g. as Genapol ED 3060 or PN 30) from Clariant GmbH, for example.

Also commercially available as emulsifiers or wetting agents and dispersants are polyalkylene oxide/bisphenol A polymers, such as the product Carbowax M20, a polyethylene oxide/bisphenol A polymer from Union Carbide Corporation. These products, though, do not contain nitrogen atoms.

WO 02/16471 describes block copolymer dispersants obtained by reacting generally aromatic starter alcohols with ethylene oxide and then carrying out reaction with, usually, propylene oxide. That document also describes reaction products of amines (e.g. N-phenyl-1-naphthylamine) with propylene oxide. On page 1 in section 3, moreover, there is a list of further patent literature available on this topic. There are no references in the said patent or in the literature references mentioned in the said patent to alkoxylations of the secondary hydroxyl group in the reaction products of amines with high molecular mass epoxides. The substances from WO 02/16471 also show weak affinity for pigment surfaces and are therefore of only limited suitability for producing, say, pigment concentrates.

It was an object of the present invention, therefore, to eliminate the above-described disadvantages of known dispersants, i.e. to develop dispersing additives which, while providing effective stabilization of pigments or fillers, reduce the millbase viscosity of the paints, pastes or plastics formulations to such an extent as to allow processing in conjunction with a high degree of filling. At the same time, especially in the case of pigment pastes and filler pastes, broad compatibility must be ensured, so that these pastes can be used in numerous different binders and coating materials. A further requirement is that the inventive dispersing additives used allow flocculation-free miscibility of the pastes, or of the binders produced using these pastes, with one another.

Surprisingly it has been found that the aminic polyalkylene oxides described below and/or their further reaction products meet the requirements described.

These aminic polyalkylene oxides are alkoxylated epoxide-amine adducts having a number-average molecular weight of more than 500 g/mol, and are preparable by reacting
a) mono- and/or polyepoxides having at least 8 carbon atoms with
b) primary and/or secondary amines and/or primary and/or secondary alkanolamines and/or secondary alkylalkanolamines, to form an adduct having one or more secondary OH groups, and subsequently alkoxylating the adduct with
c) alkylene oxides.

Components A and B are advantageously reacted with one another in proportions such that one reactive amino group is used per epoxy group. Deviations from these proportions are possible but do not bring any particular advantages. The amount in which component C is used is a function of the molecular weight of this component and of the target molecular weight of the alkoxylated epoxide-amine adducts.

The epoxide-amine adducts obtained from components A, B and C are high-value wetting agents and dispersants. They can be used as such, in the form in which they are obtained by the two-stage reaction, and achieve the technical objectives described above. In certain cases, however, it is desirable to modify them further in order to adapt their properties in individual cases to specific requirements, particularly in order to increase their compatibility with various pigments, coating materials and plastics. Modifications of this kind are described below, and may be brought about by reaction with the hydroxyl and/or amino groups in the epoxide-amine adducts. In the course of the modification they may be reacted partially or completely.

The modification reactions below can be combined with one another where necessary, to produce multiply modified products. If two or more modification reactions are carried out in succession, care should be taken to ensure that, when the individual reaction steps are being carried out, a sufficient number of reactive groups are retained in the molecule for one or more subsequent reactions.

By virtue of the reaction of components A, B and C and the subsequent modification of the resultant epoxide-amine adducts it is possible to produce a large number of different wetting agents and dispersants. These can be used individually or in combination with one another, as, for example, a mixture of different epoxide-amine adducts.

The stated modifications are advantageous embodiments of the present invention and can be realized by:
a) reacting the hydroxyl function, resulting from the alkoxylation, with hydroxycarboxylic acids and/or cyclic lactones to form (poly)esters,
b) esterifying or etherifying the hydroxyl function resulting from the alkoxylation,
c) reacting the hydroxyl function, resulting from the alkoxylation, with (poly)isocyanates or polyisocyanate adducts having at least one free isocyanate group, to form urethanes,
d) reacting with phosphoric acid or polyphosphoric acid and/or acidic phosphoric esters and/or carboxylic acids, to form the respective organic salts,
e) reacting the hydroxyl function, resulting from the alkoxylation, to give acidic phosphoric esters,
f) alkylating or oxidizing the amino group(s), to form quaternary ammonium salts or N-oxides.

The epoxy compounds mentioned under A may be monoepoxy compounds, such as styrene oxide, alkyl glycidyl ethers having at least 8 carbon atoms (e.g. C10-C16 alkyl glycidyl ethers) and alkyl-epoxyalkyl esters having at least 8 carbon atoms (e.g. 2,3-epoxypropyl neodecanoate), or polyepoxy compounds having at least 8 carbon atoms, and may be used individually or in a mixture. Preference is given to aromatic-containing epoxy compounds, since the inventive aminic polyalkylene oxides prepared using these epoxides have very good wetting and dispersing qualities. Particular preference is given to aromatic-containing polyepoxides having on average 1.5 to 5 epoxy functions per molecule, and, of these, very particular preference to the epoxides having on average 2 epoxy functions per molecule, since the aminic polyalkylene oxides prepared from them exhibit excellent wetting and dispersing qualities. Examples of these aromatic-containing polyepoxides are polyglycidyl ethers of polyfunctional phenols. By polyfunctional phenols are meant compounds which are described in WO 96/20971 (page 16 line 15 to page 17 line 18). Preferred among these phenols are diphenols, including polycyclic diphenols.

Typical examples in the group of these aromatic-containing polyepoxides are reaction products of diphenylolpropane (bisphenol A) with epichlorohydrin and the higher homologues thereof, which are offered, for example, under the brand name D.E.R. (e.g. as D.E.R. 331) or Epikote (e.g. as Epikote 828 or 1001) by the DOW Chemical Company or Resolution Performance Products, respectively.

Further examples of suitable epoxy compounds are found for example in WO 01/05900 on pages 8 and 9.

A further preferred embodiment of the products of the invention are reactions with reactants based on novolaks, as described for example in DE-A-3623297.

In the case of polyfunctional epoxides, besides the addition reaction of the amines of the invention, other reactions can also be carried out on the epoxy groups, affecting neither the addition reaction of the amines nor the subsequent alkoxylation. Thus in the case of polyfunctional epoxides, for example, before or after the addition reaction of one of the amines of the invention, some of the epoxy groups can be reacted with carboxylic acids, to form β-hydroxy esters.

With regard to the primary and/or secondary amines mentioned under B, particular suitability is possessed by the aliphatic, secondary amines, since with these amines, the reaction regime when preparing the epoxide-amine adducts can be controlled particularly well. Examples of the aforementioned secondary amines are dialkylamines, alkylcycloalkylamines, dicycloalkylamines and cyclic aliphatic amines such as pyrrolidine, piperidine and morpholine.

Particularly preferred representatives among the alkylamines and dialkylamines are amines in which the number of carbon atoms in the alkyl and/or cycloalkyl chains is between 3 and 28, such as, for example, propylamine, dipropylamine, butylamine, dibutylamine, ethylhexylamine, diethylhexylamine, and higher homologues, methylcyclohexylamine and higher homologues, cyclopentylamine, cyclohexylamine, dicyclopentylamine, dicyclohexylamine, since with these products, owing to the higher boiling point of the amines used, the reaction is accomplished particularly easily.

A further preferred embodiment are products based on primary and/or secondary alkanolamines and/or alkylalkanolamines such as, for example, ethanolamine, diethanolamine or ethylethanolamine. From this group, the products based on the alkylalkanolamines are particularly preferred, since the reaction regime when preparing the epoxide-amine adducts can be controlled particularly well.

The use of primary amines for the purposes of the aforementioned reactions is limited by the possible crosslinking of the reaction material. Thus when using polyepoxide compounds it is in many cases not possible to use equimolar amounts of primary amines, since otherwise the reaction solution undergoes crosslinking. In such cases use may be made, for example, of mixtures of primary and secondary amines in order to prevent unwanted crosslinking reactions occurring.

Besides the hydroxyl functions, the amines used to prepare the products of the invention may also carry other functional groups which behave inertly in the subsequent alkoxylation, such as, for example, alkoxy functions, e.g. 3-ethoxypropylamine, bis(2-methoxyethylamine) and/or aromatic molecular constituents such as methylbenzylamine, for example. Among the amines used with functionalities which behave inertly in the subsequent alkoxylation, preferred embodiments are primary and secondary amines having a further tertiary amino group, such as dimethylaminopropylamine, for example.

Further preferred among the amines used with further functionalities are amines having a primary or secondary amino group and a nitrogen-containing heterocycle, such as aminopropylimidazole and 2-pyrrolidinoethylamine, for example.

The reaction of the epoxy function with the amino groups to form the β-hydroxyamino function can be carried out in solvents, but preferably in bulk (without solvent), by processes that are known to the skilled person. The temperature of the reaction between the epoxy group and the amine depends on the reactivity of the adducts. Many epoxides react with amines even at RT, while for reactants of low reactivity, reaction temperatures up to 160° C. may be necessary. Particularly suitable reaction temperatures for the reaction of the epoxides of the invention with the amines of the invention are 80-140° C., since at this temperature there is a rapid reaction without disruptive side reactions. Where appropriate, catalysts known to the skilled person can be added in order to accelerate the reaction of the epoxide with the amine. The course of the reaction can be monitored analytically by means, for example, of HPLC.

The addition products formed from the (poly)epoxides and the amines are alkoxylated in a manner known to the skilled person. The alkoxylation is accompanied by the construction of a polyalkoxy chain not only on the β-hydroxy function formed during the addition reaction but also on any hydroxy functions of the (alkyl)-alkanolamine that are present, and/or on the secondary amine formed in the addition reaction of a primary amine with an epoxide. Alkoxylation can be effected using, for example, ethylene oxide, propylene oxide, butylene oxide, decene oxide and/or styrene oxide.

Particularly preferred among the abovementioned products are embodiments distinguished by the blockwise arrangement of the various alkylene oxides, these products thus, for example, carrying first a polyethylene oxide block on which, then, a polypropylene block has been polymerized. Further preferred embodiments of the basic alkoxylates are products which are liquid between 0 and 40° C.

The formation of salts of the aminic polyalkylene oxides, outlined under d), can be performed in bulk (without solvent) or in suitable solvents or carrier media. Critical for the use of solvents are the viscosities of the resultant organic salts. Thus when using poly(phosphoric acid) as acidic component there is a sharp rise in viscosity even at low levels of salt formation, necessitating in the majority of cases the use of solvent or carrier media. The degree of salification in this context should be understood as being the ratio between acid equivalents of the acids used and amine equivalents of the aminic polyalkylene oxides, and it is preferred to use values between 0.05 and 2.5 and particularly preferred to use values between 0.2 and 1, since the last-mentioned products possess the broadest usefulness for different binders and solids. Depending on the solid to be dispersed, products having a higher or lower degree of salification can be used. Thus, for example, when dispersing acidic carbon black grades it is possible to use salification products with excellent dispersing quality, which carry a high excess of basic groups, and in which, consequently, the aminic polyalkylene oxide is not completely salified with the corresponding organic acid. As well as the products which are not in fully salified form, it is entirely sensible for certain applications to use products as well which, based on the amine equivalent, carry an acid excess (degree of salification >1), as, for example, when solids are used for dispersing that are themselves basic.

Preferred embodiments for the salts of the aminic polyalkylene oxides are salts with poly(phosphoric acid) and/or acidic phosphoric esters, since these products are notable for particularly broad compatibility with different pigments and binders. Preferred embodiments of the salts with carboxylic acids are salts of the aminic polyalkylene oxides with unsaturated fatty acids and also of citric acid, since these products possess excellent qualities as wetting agents and dispersants.

The hydroxyl groups that are formed during the alkoxylation and the polyesterification, described below, can be converted as mentioned in e), in a manner known to the skilled person, into acidic phosphoric ester groups.

The synthesis of acidic phosphoric esters is described by way of example in Houben-Weyl “Methoden der organischen Chemie” volume XII/2, 4th edition, p. 143 ff. Depending on the nature of the phosphorylating reagent used (e.g. P₂O₅, PCl₅, polyphosphoric acid (PPS), and in accordance with the stoichiometric amount of phosphorylating reagent used to phosphorylating component (R¹OH), monoesters or diesters or else mixtures of both species are formed. With the aid of relatively new phosphorylation methods it is possible to control the amount of phosphoric monoester and diester within wide limits (EP 0 675 076, EP 01 207 135). It is also possible to use a mixture of different components to be phosphorylated in the phosphorylation reaction. As the skilled person is aware, it is possible when using polyphosphoric acids with relatively high degrees of condensation for not only the phosphoric esters but also, in varying proportions, polyphosphoric esters to be formed.

A particular difficulty when phosphorylating the aminic polyalkylene oxides of the invention is the presence of the amino group. Phosphorylating the hydroxyl groups with polyphosphoric acid, for example, is readily possible only when the amino group has been salified, for example, beforehand. This salification may advantageously occur as a result of using an excess in the case of acidic phosphorylating reagents. In some cases satisfactory reaction rates are achieved only with considerable excesses.

The inventive, acidic phosphoric esters of the aminic polyalkylene oxides, set out under b), are suitable in bulk (without solvent) or else in neutralized form, in particular fashion, for dispersing inorganic pigments such as titanium dioxide or iron oxide, for example, since with these products particularly high degrees of pigment filling are possible.

The hydroxyl groups formed during the alkoxylation can be esterified or etherified as noted under b). The esterification or etherification takes place in the way which is known to the skilled person, with the restriction that the amino group in many cases must first be salified, for example, before the esterification or etherification of the hydroxyl groups can be carried out with a satisfactory reaction rate. Esterified or etherified aminic polyalkylene oxides of the invention are preferable in certain cases to the unesterified or unetherified aminic polyalkylene oxides, since with certain binders free hydroxyl groups react undesirably and so lower the storage stability of the systems.

A preferred embodiment of the esterified aminic polyalkylene oxides are modifications which carry a polymerizable unit, such as is formed, for example, during the esterification with acrylic acid or methacrylic acid, or during transesterification with alkyl (meth)acrylates. Such esterification can be carried out under particularly gentle process conditions, and hence with particular preference, by means of an enzymatically catalyzed esterification. A further preferred embodiment of the esterified aminic polyalkylene oxides are modifications which can be incorporated into certain coating systems in the course of curing. Such modifications, which can be incorporated into alkyd paints, for example, come about, for example, during esterification with (poly)unsaturated (conjugated) carboxylic acids such as oleic acid, linoleic acid and linolenic acid, for example.

A further variant for the modification of the hydroxyl group formed during the alkoxylation is that of reaction with hydroxycarboxylic acids and/or cyclic lactones to form (poly)esters. The reaction takes place in the way which is known to the skilled person. As a result of the presence of the amino group at the same time there is in many cases a distinct decrease in the reaction rate as compared with products without amino functions, which can be compensated only partly by raising the amount of catalyst. A preferred embodiment of the abovementioned (poly)esters of the aminic polyalkylene oxides are products based on cyclic lactones such as, for example, ε-caprolactone and/or δ-valerolactone as reactants. In this reaction the terminal OH groups are retained. Products of this kind are notable for particularly broad compatibility in numerous coating systems.

In accordance with c) the hydroxyl groups formed in the alkoxylation or polyesterification can also be reacted with isocyanates to give urethanes. Urethane formation is carried out in the way which is known to the skilled person. In the majority of cases, owing to the tertiary amino function, there is no need for catalysis. The conversion of the hydroxyl group into a urethane group is appropriate, as in the case of esterification or etherification, if hydroxyl groups are disruptive to the coating system. Moreover, the formation of urethane often has beneficial consequences for the foam suppressant effect of the wetting agents and dispersants. Suppressing the propensity to foam is a valuable additional function of such wetting agents and dispersants particularly in the case of dispersion in aqueous formulations.

As set out under f), the quaternized form of the aminic polyalkylene oxides can also be used. Quaternization takes place in a way which is known to the skilled person, for example with alkyl halides or aralkyl halides, with halocarboxylic esters or with epoxides. An embodiment of this kind is preferable, for example, when amino groups disrupt the binder system into which the pigment concentrates are incorporated. A particularly preferred embodiment of the quaternized aminic polyalkylene oxides are alkoxylated reaction products of polyepoxides with primary and secondary amines which carry a further tertiary amino group, such as dimethylaminopropylamine, for example, which are subsequently quaternized.

The dispersants of the invention can be used in accordance with the prior art for known dispersants. The dispersants can be used alone or together with binders. When used in polyolefins it may be advantageous, for example, to use corresponding low molecular mass polyolefins as carrier materials together with the dispersant.

Use of the products of the invention as wetting agents and dispersants for pigment preparations in the area of the production of what are known as colour resists (constituents of liquid-crystal colour screens), of pigment preparation for anodic and, preferably, cathodic electrodeposition coatings, and application in ink-jet inks represent three particularly preferred fields of application.

Besides the use of the reaction products of the invention as dispersants and as dispersion stabilizers, this invention also provides the coating of powderous or fibrous solids with the products of the invention. Coatings of this kind on both organic and inorganic solids are carried out in a known way, as described, for example, in EP-A-0 270 126. The solvent or emulsion medium may either be removed or remain in the mixture, forming pastes. These pastes are standard commercial products and may further comprise binder fractions and also additional auxiliaries and additives. In the case of pigments specifically the pigment surface may be coated during or after pigment synthesis, by, for example, adding the products of the invention to the pigment suspension, or during or after pigment finishing.

The pigments thus pretreated are notable for greater ease of incorporation in the binder and also by improved viscosity, flocculation and gloss behaviour in relation to untreated pigments.

As well as the above-described application as coating materials for powderous and fibrous solids, the dispersants of the invention can also be used as viscosity reducers and compatibilizers in synthetic resins. Examples of such synthetic resins are those known as sheet moulding compounds (SMC) and bulk moulding compounds (BMC), which are composed of unsaturated polyester resins with high levels of filler and fibre. In order to obtain high stiffness, good surface quality, and flame retardancy properties (in the case of fillers such as Al(OH)₃ or Mg(OH)₂, for example), it is necessary to fill these systems with high levels of fillers and fibres, leading to a sharp rise in the viscosity of the SMC and BMC blends and to problems associated with the wetting of the fibres. A further problem associated with SMC and BMC synthetic resin blends is that often polystyrene (PS) is added to the formulation in order to reduce contraction during the processing operation. PS is not compatible with the unsaturated polyester resins used, and the components separate. Through use of the products of the invention it is possible to sharply reduce the viscosity of the resin/filler mixtures, thereby allowing a high degree of filling, which benefits the mechanical properties, the surface quality, and, when using Al(OH)₃ or Mg(OH)₂, the flame retardancy effect. When using PS-filled SMC or BMC blends, the additives of the invention, by virtue of their good dispersing qualities, are able to bring about compatibilization between PS and unsaturated polyester resin, thereby increasing the storage stability and processing reliability of such blends.

The dispersants of the invention are used preferably in an amount of 0.5 to 100% by weight, based on the solid to be dispersed. For dispersing specific solids, however, it is entirely possible that substantially higher amounts of the dispersants will be necessary.

The amount of dispersant is dependent essentially on the type and size of the surface to be covered on the solid that is to be dispersed. Carbon black, for example, requires substantially greater amounts of dispersant than, say, TiO₂. Examples of pigments or fillers are found in EP-A-0 270 126. Further examples are recent developments particularly in the field of organic pigments, such as the class of the diketopyrrolopyrroles, for example, but also magnetic pigments based, for example, on pure iron or on mixed oxides. Furthermore, it is also possible to disperse mineral fillers, examples being calcium carbonate and calcium oxide, and also flame retardants such as aluminium hydroxide and magnesium hydroxide, for example. Matting agents such as silicas, for example, can likewise be dispersed and stabilized. One further particularly appropriate field of use of the dispersants of the invention is in the dispersing of nanoparticles made, for example, of SiO₂, Al₂O₃ or ZnO, since in this application the dispersants of the invention are prized for a desired, sharp reduction in viscosity during the dispersing of the nanoparticles.

### EXAMPLES

The invention is further illustrated by the examples below. Unless indicated otherwise, parts and percentages are by weight. In the case of substances lacking molecular uniformity, the stated molecular weights represent average values of the number average. In the case of reaction of the amines with the (poly)epoxides the stoichiometry of the reaction is selected such that one reactive amino group (for example, in the case of dimethylaminopropylamine, only the primary amino group) is used per epoxy group. The moles of alkoxylating agent used in the alkoxylation relate in every case to the total molecule to be alkoxylated. The following abbreviations have been selected for the various alkoxylating agents:
Ethylene oxide: EO
Propylene oxide: PO
Butylene oxide: BO
Decene oxide: DO
Styrene oxide: SO

EO-28; PO-49 in the third example means that 28 mol of ethylene oxide and 49 mol of propylene oxide are reacted with the adduct of diethanolamine and D.E.R. 331.

The alkoxylation variant term defines whether the alkoxylation is carried out with different alkoxylating agents sequentially, to form block structures, or as what is referred to as gasmix supply, to form unordered structures, or random structures, as they are known (random for short). In the case of the block structures the sequence of the alkoxylating agents listed indicates the sequence of the various blocks, starting from the amine-(poly)epoxy adduct. Thus, for example, in Example 18 EO-block-PO means that first the EO block is polymerized onto the adduct of dibutylamine and D.E.R. 331 and then, subsequently, the PO block is polymerized onto the completed EO block.

TABLE 1
Examples of unmodified aminic polyalkylene oxides

| | Amine | | Alkoxylating | Alkoxylation |
|---|---|---|---|---|
| Example No. | used | Epoxide used | agent used | variant |
| 1 | diethanolamine | D.E.R. 331*¹ | EO-25 | random |
| | (2,2′- | | | |
| | iminodiethanol) | | | |
| 2 | diethanolamine | D.E.R. 331 | PO-25 | random |
| 3 | diethanolamine | D.E.R. 331 | EO-28; PO-49 | random |
| 4 | diethanolamine | D.E.R. 331 | EO-5; PO-65 | random |
| 5 | ethylethanolamine | D.E.R. 331 | EO-112; | random |
| | (2- | | PO-85 | |
| | ethylaminoethanol) | | | |
| 6 | ethylethanolamine | D.E.R. 331 | EO-68; | random |
| | | | PO-119 | |
| 7 | di-n-butylamine | D.E.R. 331 | EO-28; | random |
| | | | PO-49; BO-28 | |
| 8 | di-n-butylamine | D.E.R. 331 | EO-28; | random |
| | | | PO-49; SO-1 | |
| 9 | di-n-butylamine | D.E.R. 331 | EO-49; PO-38 | random |
| 10 | di-n-butylamine | D.E.R. 331 | EO-28; PO-49 | random |
| 11 | di-n-butylamine | D.E.R. 331 | EO-5; PO-65 | random |
| 12 | oleylamine | D.E.R. 331 | EO-54; PO-97 | random |
| | (9-octadecene-1- | | | |
| | amine) | | | |
| 13 | aniline | D.E.R. 331 | EO-54; PO-97 | random |
| 14 | dimethylamino- | D.E.R. 331 | EO-54; PO-97 | random |
| | propylamine (1,3- | | | |
| | propanediamine, | | | |
| | N,N-dimethyl-) | | | |
| 15 | aminopropyl- | D.E.R. 331 | EO-54; PO-97 | random |
| | imidazole (1H- | | | |
| | imidazole-1- | | | |
| | propylamine) | | | |
| 16 | pyrrolidine | D.E.R. 331 | EO-5; PO-10 | random |
| 17 | cyclohexylamine | D.E.R. 331 | EO-28; PO-49 | random |
| 18 | dibutylamine | D.E.N. 431*² | EO-49; PO-86 | random |
| 19 | ethylethanolamine | styrene oxide | EO-10; PO-5 | random |
| 20 | ethylethanolamine | Grilonit | EO-10; PO-5 | random |
| | | RV 1418*³ | | |
| 21 | di-n-butylamine | Epikote 1001*⁴ | EO-5; PO-10 | random |
| 22 | di-n-butylamine | D.E.R. 331 | EO-28; PO-49 | EO-block-PO |
| 23 | di-n-butylamine | D.E.R. 331 | EO-28; PO-49 | PO-block-EO |
| 24 | di-n-butylamine | D.E.R. 331 | EO-49; PO-38 | EO-block-PO |
| 25 | di-n-butylamine | D.E.R. 331 | EO-38; PO-49 | PO-block-EO |

*¹D.E.R. 331 is a commercial product of Dow Deutschland Inc. It is a low molecular mass, liquid epoxy resin based on bisphenol A.
*²D.E.N. 431 is a commercial product of Dow Deutschland Inc. It is a liquid epoxy novolak.
*³Grilomit RV1814 is a commercial product of Ems Primid. It is a C13/C15- alkylglycidyl ether.
*⁴Epikote 1001 is a commercial product of Shell AG. It is a high molecular mass, solid epoxy resin based on bisphenol A.

TABLE 2
Overview table with examples of modified aminic polyalkylene
oxides elucidated in more detail below:

| Example | Starting product | |
|---|---|---|
| No. | for the modification | Type of modification |
| 26 | Example 9 | Salification with phosphoric |
| | | acid |
| 27 | Example 11 | Salification with nonpolar |
| | | polyphosphoric ester |
| 28 | Example 18 | Salification with polar |
| | | polyphosphoric ester |
| 29 | Example 5 | Salification with citric acid |
| 30 | Example 10 | Phosphorylation of the OH |
| | | group |
| 31 | Example 11 | Esterification with fatty |
| | | acid |
| 32 | Example 10 | Polyesterification with |
| | | ε-caprolactone |
| 33 | Example 11 | Quaternization with CH₃I |
| 34 | Example 14 | Quaternization with benzyl |
| | | chloride |
| 35 | Example 11 | Reaction with stearyl |
| | | isocyanate |

### Example 26

100 parts of the reaction product from Example 22, which has an amine number (AmN) of 22.8 mg KOH/g, are salified with 5.9 parts of 85% strength phosphoric acid, measured acid number (AN) 973 mg KOH/g. This gives a clear, yellow reaction product. The degree of salification in this example is 2.5.

### Example 27

85 parts of the reaction product from Example 11, which has an AmN of 21.9 mg KOH/g, are salified with 15.1 parts of a phosphoric monoester (HO)₂PO(OR¹) with R¹=butoxypoly(ethylene glycol-co-propylene glycol) (Mₙ:1000 g/mol, ethylene glycol/propylene glycol ratio ˜1:1, AN˜98.7 mg KOH/g; referred to below as phosphoric ester A) at 50° C. with intensive stirring. This gives a clear, viscous, brown product. The degree of salification in this example is 0.8.

### Example 28

75 parts of the reaction product from Example 18, which has an AmN of 19.1 mg KOH/g, are salified with 16.6 parts of phosphoric ester A at 50° C. with intensive stirring. This gives a clear, viscous, brown product. The degree of salification in this example is 0.8.

### Example 29

150 parts of the reaction product from Example 5, which has an AmN of 10.1 mg KOH/g, are salified with 0.52 parts of citric acid at 50° C. This gives a clear, viscous, yellow product. The degree of salification in this example is 0.3.

### Example 30

100 parts of the reaction product from Example 10 are admixed over a period of 5 minutes with 9.5 parts of polyphosphoric acid at 60° C. with intensive stirring. During this time a sharp rise in viscosity is observed. The temperature is raised to 80° C. and over the course of 5 hours the acid number climbs from an initial value of 88.7 mg KOH/g to a final value of 100.4 mg KOH/g. The reaction product after cooling is a yellow, clear liquid of high viscosity.

### Example 31

150 parts of the epoxide-amine adduct from Example 11 are mixed with 37.4 parts of tall oil fatty acid (measured acid No. 193 mg KOH/g). With this mixing ratio the tall oil fatty acid is used approximately in twice-molar excess relative to the hydroxyl groups that are to be esterified. The mixture is mixed with one part of para-toluenesulphonic acid as catalyst and is heated to 180° C. with stirring. A gentle stream of nitrogen removes water of reaction from the reaction mixture. After approximately 3.5 h under these reaction conditions, the reaction temperature was raised to 200° C. After a further 7.5 hours the amine number of the reaction solution has dropped to a level of 27.1 mg KOH/g. Hence approximately more than 50% of all the hydroxyl groups were esterified with the tall oil fatty acid. This gives a yellow-brown, clear product.

### Example 32

150 parts of the reaction product from Example 10, having a hydroxyl number (OHN) of 31.7 mg KOH/g, are mixed with 96.7 parts of ε-caprolactone and 200 ppm of dibutyltin dilaurate (DBTL). In an N₂ atmosphere the components are heated to 160° C. with stirring. After reaction times of 6 h and 12 h a further 100 ppm in each case of DBTL are added. Within the total reaction time of approximately 15 h, the solids content of the reaction solution has risen to >98%. After cooling, the polyester is in the form of a brown, partially crystalline reaction product which can be diluted in suitable solvents before further use.

### Example 33

100 parts of the reaction product from Example 9, having an AmN of 21.9, are mixed with 5 parts of methyl iodide (90 mol % based on the nitrogen atoms to be alkylated) and the mixture is stirred at 30° C. under an N2 atmosphere for 12 h. Within this time the AmN has dropped to a level of 2.2, corresponding almost to the theoretical figure. Moreover, the viscosity of the reaction solution has increased significantly. A viscous yellow reaction product is obtained.

### Example 34

150 parts of the reaction product from Example 14, having an amine number of 10.1 mg KOH/g, are mixed with 3.08 parts of benzyl chloride. The molar ratio between reaction product from Example 14 and benzyl chloride was selected so that about 90% of the dimethylaminoalkyl groups are alkylated. After 3 hours' reaction time at 120° C. in an N₂ atmosphere, the amine number has dropped to a level of 11.2 mg KOH/g, corresponding approximately to the theoretical figure. In preliminary experiments it was shown that, under these reaction conditions and using this alkylating reagent, it is almost exclusively the dimethylaminoalkyl groups that are alkylated. A clear, yellow-orange, viscous reaction product is obtained.

### Example 35

175 parts of the reaction product from Example 11, having an OHN of 24.1, are mixed with 21.4 parts of stearyl isocyanate and the mixture is heated to 80° C. under an N2 atmosphere. This corresponds to a 0.857 molar deficit of isocyanate groups in relation to the OH groups of the aminic polyalkylene oxide. The isocyanate content was determined immediately prior to reaction. After a reaction time of approximately 3 h the isocyanate group content has fallen to <0.01% and the reaction is therefore at an end. A white reaction product is obtained, with partial crystallization.

### APPLICATION EXAMPLES

To test the activity of the dispersants of the invention, pigment pastes were produced with various modified and unmodified aminic polyalkylene oxides. In parallel with this, pigment pastes with commercially available, non-inventive aminic polyalkylene oxides were produced as well, since these products are chemically the most similar to the substances of the invention, are available commercially, and so represent the state of the art in the field of aminic polyalkylene oxides. Water-based pigment pastes were produced, and also solvent-borne pigment pastes for use in solvent-based binder systems.

The pigment pastes thus obtained were investigated for their performance by incorporating them into binder systems. Following application and curing of the finished pigmented coating materials, colour strength measurements were then performed on the drawdowns. Furthermore, viscosity measurements were performed on the pigment pastes.

TABLE 3
Formula of the water-based pigment pastes (colour pastes):

| | Bayferrox 130 M*¹ | Heliogenblau L 7101 F*² |
|---|---|---|
| Water | 32.4 | 56.9 |
| N & D additive | 6.0 | 12.0 |
| Byk 024*³ | 1.0 | 1.0 |
| Ebotec BT 20*⁴ | 0.1 | 0.1 |
| Pigment | 60.0 | 30.0 |
| Byk 420*⁵ | 0.5 | — |
| | 100.0 | 100.0 |

*¹Bayferrox 130 M is an inorganic red pigment from Bayer AG
*²Heliogenblau L 7101F M is an organic blue pigment from BASF AG
*³Byk 024 is a silicone-containing defoamer from BYK Chemie GmbH
*⁴Ebotec BT 20 is a preservative from Bode Chemie Hamburg
*⁵Byk 420 is a rheology additive from BYK Chemie GmbH.

100 parts of glass beads (diameter 1 mm) are added to 100 parts of the above mixture and the resulting mixture is dispersed in a vertical bead mill from Getzmann (Dispermat CV) for 40 minutes at 40° C., using a polypropylene disc with a diameter of 40 mm, at a peripheral speed of 18 m/s in the case of Bayferrox 130 M and 23 m/s in the case of Heliogenblau 7101F. Additionally, under similar conditions (peripheral speed 18 m/s, dispersing time 30 minutes) a white paste was produced using a standard commercial wetting and dispersing agent.

TABLE 4
Formula of the white paste

| | |
|---|---|
| Water | 24.9 |
| Disperbyk 190*² | 3.5 |
| Byk 024 | 1.0 |
| Ebotec BT 20 | 0.1 |
| Kronos 2160*¹ | 70.0 |
| Byk 420 | 0.5 |
| | 100.0 |

*¹Kronos 2160 is a titanium dioxide pigment from Kronos Inc.
*²Disperbyk 190 is a wetting agent and dispersant from BYK-Chemie

To test the dispersing quality, the colour pastes and the white paste were mixed for 5 minutes in a Skandex shaker with a standard commercial clear varnish, to the following formula:

TABLE 5
Formula of the white blends

| Proportions of the | | |
|---|---|---|
| components | Bayferrox 130 M | Heliogenblau L 7101 F |
| Clear varnish | 8.8 | 8.8 |
| White paste | 3.8 | 3.8 |
| Colour paste | 0.9 | 0.4 |
| | 13.5 | 13.0 |

The standard commercial clear varnish was produced on the basis of Joncryl SCX 8280, to the following formula:

TABLE 6
Formula of the clear varnish based on Joncryl SCX 8280

| | |
|---|---|
| Joncryl SCX 8280*¹ | 87.7 |
| Butoxyethanol | 3.2 |
| Texanol*² | 1.3 |
| Rheolate 278*³ | 1.3 |
| 32% ammonia | 0.4 |
| Water | 5.0 |
| Byk 024*⁴ | 0.7 |
| Byk 346*⁵ | 0.3 |
| | 100.0 |

*¹Joncryl SCX 8280 is an acrylic dispersion from Johnson Polymers Ltd.
*²Texanol is a high-boiling ester alcohol from Eastman Chemical Company
*³Rheolate 278 is a PU thickener from Elementis
*⁴Byk 024 is a silicon-containing defoamer from BYK Chemie GmbH
*⁵Byk 346 is a silicone surfactant for improving substrate wetting, from BYK Chemie GmbH.

The finished coating materials are then applied in a wet film thickness of 100 μm to contrast charts (No 2853) from BYK-Gardner, using a box-type coating bar.

After the coating materials have been dried at room temperature, measurements are made of the gloss, at an angle of observation of 60°, and of the haze of the coatings, using a gloss-haze measuring instrument from Byk-Gardner. The pigment stabilization of the white blend is measured on the basis of the difference in shade, relative to the unrubbed coating material, which arises when a “rub-out” is carried out (i.e. when the applied coating material is rubbed shortly before the applied material has dried). This shade difference (ΔE value) is determined using a colorimeter from BYK-Gardner (colour guide, sphere, observation angle 10°). The smaller the ΔE value, the better the stabilization of the blend.

TABLE 7
Results of the gloss and haze measurements with Heliogenblau 7101F

| Product from | Degree of gloss | Haze | ΔE |
|---|---|---|---|
| Example 5 | 81 | 154 | 0.25 |
| Example 18 | 69 | 265 | 1.50 |
| Example 23 | 82 | 87 | 1.00 |
| Example 24 | 84 | 75 | 0.70 |
| Example 25 | 80 | 131 | 0.40 |
| Example 26 | 78 | 154 | 0.74 |
| Tetronic RED | * | * | * |
| 9040*¹ | | | |

*¹In order to demonstrate the state of the art, a dispersion and performance testing were carried out in accordance with the above conditions, using Tetronic RED 9040 as wetting agent and dispersant. Tetronic RED 9040, a product of BASF AG, is an EO/PO block polymer based on ethylenediamine, having a molecular weight of approximately 7200 g/mol.

In this case it was not possible to measure gloss and haze, since the pigment paste with Tetronic RED 9040 was very highly agglomerated.

TABLE 8
Results of the gloss and haze measurements with Bayferrox 130 M

| Product from | Degree of gloss | Haze | ΔE |
|---|---|---|---|
| Example 5 | 83 | 89 | 1.10 |
| Example 18 | 84 | 82 | 1.70 |
| Example 23 | 83 | 82 | 1.00 |
| Example 24 | 83 | 93 | 2.80 |
| Example 25 | 83 | 93 | 0.90 |
| Example 26 | 82 | 114 | 2.60 |
| Tetronic RED | 78 | 206 | 6.80 |
| 9040 | | | |

As evident from Table 7 and 8, only the pigmented coating materials produced with the products of the invention lead to coatings having high gloss, low haze and acceptable ΔE values. A similar picture emerges for pigmented coating materials produced with other dispersants of the invention, and with other pigments.

With the non-inventive product, no acceptable dispersion was possible in the case of Heliogenblau 7101F. On dispersion of Bayferrox 130M, the non-inventive product had poorer gloss and haze values that displayed weaknesses above all in the ΔE value.

In order to demonstrate the strengths of the products of the invention with respect to the breadth of application, they were also used as wetting agents and dispersants in a solvent-based binder system.

TABLE 9
Formula of the solvent-borne, binder-free pigment pastes

| Formula for: | Additives in 100% form | Additives in 52% form |
|---|---|---|
| Propylene glycol | 59.6 | 51.5 |
| monomethyl ether | | |
| acetate | | |
| Dimethyl succinate | 6.6 | 6.6 |
| Additive | 8.8 | 16.9 |
| Spezialschwarz 4*¹ | 25 | 25 |
| | 100 | 100 |

*¹Spezialschwarz 4 is a carbon black pigment from Degussa AG

100 parts of glass beads (diameter 1 mm) are added to 100 parts of the above mixture and the resulting mixture is dispersed in a vertical bead mill from Getzmann (Dispermat CV) for 60 minutes at 40° C., using a polypropylene disc 40 mm in diameter, with a peripheral speed of 23 m/s. The resulting pastes were sieved to remove the glass beads and then subjected to viscosity measurement. This was done using a Stresstech rheometer from Rheologica. Measurement took place in cone/plate geometry with a plate diameter of 25 mm and a cone angle of 1° at 23° C. and at different shear rates.

TABLE 10
Viscosity measurements of the binder-free, solvent-borne
pigment pastes (Spezialschwarz 4)

| | Viscosities in mPas at a shear rate of | | | |
|---|---|---|---|---|
| Paste with product from | 3 1/S | 10 1/S | 100 1/S | 1000 1/S |
| Example 7 | 1060 | 460 | 142 | 42 |
| Example 8 | 1560 | 649 | 166 | 43 |
| Example 10 | 895 | 516 | 137 | 40 |
| Example 15 | 667 | 388 | 113 | 37 |
| Example 18 | 334 | 221 | 87 | 35 |
| Example 22 | 1050 | 501 | 149 | 44 |
| Example 23 | 2310 | 962 | 225 | 56 |
| Example 24 | 565 | 332 | 105 | 39 |
| Example 25 | 2090 | 826 | 207 | 54 |
| Example 28 | 907 | 480 | 136 | 44 |
| Example 29 | 1090 | 556 | 155 | 53 |
| Example 34 | 367 | 248 | 92 | 36 |
| Disperbyk 2050*¹ | 85 500 | 30 300 | 2900 | 892 |

*¹Disperbyk 2050 is a wetting agent and dispersant from Byk-Chemie, representing state of the art for binder-free dispersions.

To test the quality of dispersion, 2.4 parts of each of the colour pastes are mixed for 5 minutes with a standard commercial solvent-borne alkyd resin in a Skandex shaker, to the following formula:

TABLE 11
Formula of the alkyd-melamine baking varnish based on
Vialkyd AC 451

| | |
|---|---|
| Vialkyd AC 451*¹ | 63.5 |
| Maprenal MF 800, 70% | 20.2 |
| Butanol | 2.0 |
| Solvent Naphtha | 13.8 |
| Byk 310*³ | 0.2 |
| Byk 066*⁴ | 0.3 |
| | 100.0 |

*¹Vialkyd AC 451 is an alkyd resin from Vianova
*² Maprenal MF 800 is a melamine resin from Solutia
*³Byk 310 is a flow control additive from BYK Chemie GmbH
*⁴Byk 066 is a silicone-containing defoamer from BYK Chemie GmbH

Prior to application, the coating material is adjusted with xylene to a flow time of 25 s in a DIN 4 cup. The coating material thus adjusted is then poured onto polyester film, dried at room temperature for 10 minutes and baked in a paint drying oven at 140° C. for 30 minutes. The standard used in this case was Disperbyk 2050, an acrylate copolymer having groups possessing pigment affinity, developed specifically as a wetting agent and dispersant for binder-free, solvent-borne pigment concentrates.

TABLE 12
Results of the gloss and haze measurements with the pigment
Spezialschwarz 4

| Product from | Degree of gloss | Haze |
|---|---|---|
| Example 7 | 85 | 10 |
| Example 8 | 86 | 9 |
| Example 10 | 87 | 8 |
| Example 15 | 86 | 10 |
| Example 18 | 86 | 9 |
| Example 22 | 87 | 8 |
| Example 23 | 87 | 9 |
| Example 24 | 87 | 8 |
| Example 25 | 85 | 9 |
| Example 28 | 87 | 9 |
| Example 29 | 86 | 11 |
| Example 34 | 87 | 8 |
| Disperbyk 2050 | 84 | 30 |

All products of the invention exhibit very good gloss and haze values. The coating material produced with the paste containing Disperbyk 2050 also shows a good gloss value, but a relatively high haze value. In the case of the paste viscosities (Table 10), however, great differences can be seen. All pastes with the products of the invention exhibit extremely low viscosities as compared with the industrial standard Disperbyk 2050, and on account of this allow substantially higher degrees of pigment filling during dispersion. A similar picture emerges for pigmented coating materials produced with other dispersants of the invention, and with other pigments.

Hence the object of the present invention, namely to combine effective pigment stabilization with a reduction in the mill base viscosity of the pastes to a point where processing is possible with a high degree of filling, has been met. Additionally it has been possible, through the use of the alkoxylated epoxide-amine adducts of the invention, to demonstrate the particularly broad compatibility of the products not only in aqueous formulations but also in solvent-borne formulations.

A further field of use of the products of the invention is their use as wetting agents and dispersants for pigments which are to be employed in coating systems comprising cellulose acetobutyrate (CAB) as a constituent. As the skilled person is aware, coating systems of this kind tend towards severe pigment aggregation. Through the use of the additives of the invention it has been possible to produce aggregation-free pigmented coating materials having good performance properties.

TABLE 13
Formula of the mill base for producing a CAB coating material

| | Additive with 40% | Additive with 100% active |
|---|---|---|
| | active substance | substance |
| Dynapol H 703, | 49.0 | 49.0 |
| 65% in xylene*¹ | | |
| Gasruβ FW 200*² | 8.0 | 8.0 |
| Additive | 14.0 | 5.6 |
| Butyl acetate | 29.0 | 37.4 |
| | 100.0 | 100.0 |

*¹Dynapol H 703 is a polyester resin from Degussa AG
*²Gasruβ FW 200 is a carbon black pigment from Degussa AG

100 parts of glass beads (diameter 1 mm) are added to 100 parts of the above mixture and the resulting mixture is dispersed in a vertical bead mill from Getzmann (Dispermat CV) at 40° C. for 60 minutes, using a polypropylene disc 40 mm in diameter, with a peripheral speed of 23 m/s. After the glass beads have been removed by sieving, the coating material is made up to the following formula:

TABLE 14
Letdown material

| | |
|---|---|
| Dynapol H 703, 65% | 34.7 |
| in xylene | |
| CAB solution*¹ | 42.6 |
| Maprenal MF 650*² | 20.9 |
| Byk 306*³ | 1.8 |
| | 100.0 |

*¹CAB solution consisting of 15 parts of CAB 381-2, from Eastman Chem. Comp., in 85 parts of 2:1 butyl acetate/xylene
*²Maprenal MF 650 is a melamine resin from Solutia
*³Byk 306 is a flow control additive from BYK Chemie GmbH

TABLE 15
Letdown

| | |
|---|---|
| Mill base | 13.2 |
| Letdown material | 36.3 |
| Butyl acetate | 50.5 |
| | 100.0 |

The components of the letdown were mixed for 10 minutes in a Skandex shaker, then diluted 1:1 with butyl acetate and poured onto polyester film. The coating material was flashed off at room temperature for 15 minutes and subsequently baked in a paint drying oven at 140° C. for 30 minutes. The quality of the coating was assessed visually.

TABLE 16
Visual assessment of the coating material with different additives

| Additive used from | Visual assessment of the coating material |
|---|---|
| Example 9 | Glossy, transparent coating without visible pigment |
| | aggregates |
| Example 11 | Glossy, transparent coating without visible pigment |
| | aggregates |
| Disperbyk 161*¹ | Glossy coating with reduced |
| | transparency and clearly visible |
| | pigment aggregates |

*¹Disperbyk 161 is a wetting agent and dispersant from Byk-Chemie, which may be regarded as state of the art for high-value coatings.

For CAB-containing coating systems as well, the excellent qualities, especially in respect of the breadth of applicability of the products of the invention, as wetting agents and dispersants in different coating formulations have been shown.

All references cited herein are incorporated by reference for all purposes as if repeated in their entirety herein. The foregoing examples are illustrative of the present invention. However, the following claims and the general description set forth the scope of the invention. Use of the articles “a” and “an” refer to the singular as well as the plural so that a description of an alkoxylated epoxide-amine adduct refers to a single adduct as well as a plurality of such adducts. The use of these articles also means at least one of the stated components and also means a plurality of the stated components.

1. An alkoxylated epoxide-amine adduct having a number-average molecular weight of more than 500 g/mol, which a reaction product of
A) a monoepoxide, a polyepoxide having at least 8 carbon atoms, or any combination thereof, and
B) a primary amine, a secondary amine, a primary alkanolamine, a secondary alkanolamine, a secondary alkylalkanolamine, or any combination thereof, and
C) an alkylene oxide,
wherein components A and B form an adduct having one or more secondary OH groups, and the adduct is alkoxylated with component C.

2. An epoxide-amine adduct according to claim 1, wherein component A is an aromatic monoepoxide, an aromatic polyepoxide, or a combination thereof.

3. An epoxide-amine adduct according to claim 1 wherein the OH groups resulting from the alkoxylation are converted to (poly)ester moieties by their reaction with a hydroxycarboxylic acid, a cyclic lactone or a combination thereof.

4. An epoxide-amine adduct according to claim 1, wherein the OH groups formed in the alkoxylation are esterified or etherified, or formed into urethane groups by reaction with a monoisocyanate, a polyisocyanate or with a polyisocyanate adduct containing at least one free isocyanate group.

5. An epoxide-amine adduct according to claim 3, wherein the OH groups formed in the polyesterification are esterified or etherified, or formed into urethane groups by reaction with a monoisocyanate, a polyisocyanate or with a polyisocyanate adduct containing at least one free isocyanate group.

6. An epoxide-amine adduct according to claim 1, which is converted into a salt of a phosphoric acid or polyphosphoric acid and/or acidic phosphoric esters and/or carboxylic acids.

7. An epoxide-amine adduct according to claim 1, wherein the OH groups formed in the alkoxylation or polyesterification are converted to acidic phosphoric ester groups.

8. An epoxide-amine adduct according to claim 1, wherein the amino group or amino groups present in the adducts are converted into quaternary ammonium salts or N-oxides.

9. A process for preparing an alkoxylated epoxide-amine adduct, comprising reacting
A) a monoepoxide or a polyepoxide having at least 8 carbon atoms, or a combination thereof, with
B) a primary amine, a secondary amine, a primary alkanolamine, a secondary alkanolamine, a secondary alkylalkanolamine or any combination thereof, to form an adduct having one or more secondary OH groups, and, reacting the adduct with
C) an alkylene oxide.

10. A process according to claim 9, wherein an aromatic monoepoxide or an aromatic polyepoxide or a combination thereof is used as component A).

11. A process according to claim 9, wherein the OH groups resulting from the alkoxylation are reacted with hydroxycarboxylic acids and/or cyclic lactones to produce polyester moieties.

12. A process according to claim 9, wherein the OH groups formed in the alkoxylation are esterified or etherified, or are reacted with a monoisocyanate or a polyisocyanate or a polyisocyanate adducts containing at least one free isocyanate group to form urethane groups.

13. A process according to claim 11, wherein the OH groups formed in the polyesterification are esterified or etherified or are reacted with a monoisocyanate or a polyisocyanate or a polyisocyanate adducts containing at least one free isocyanate group to form urethane groups.

14. A process according to claim 9, wherein the OH groups formed in the alkoxylation or polyesterification are converted to acidic phosphoric ester groups.

15. A process according to claim 9, wherein the amino group or amino groups present in the adducts are converted with phosphoric acid or polyphosphoric acid and/or acidic phosphoric esters and/or carboxylic acids, to form salts.

16. A process according to claim 9, wherein the amino group or amino groups present in the adducts are converted by alkylation or oxidation to form quaternary ammonium salts or N-oxides.

17. A method for wetting and/or dispersing organic and/or inorganic pigments and/or fillers comprising combining an epoxide-amine adduct according to claim 1 with the organic and/or inorganic pigment and/or filler.

18. A powderous or fibrous solid coated with an epoxide-amine adduct according to claim 1.

19. A process according to claim 9 wherein the reaction of the alkylene oxide produces a polyalkylene oxide moiety having a number-average of more than 500 g/mol.
